(19) United States
(12) Patent Application Publication
(10) Pub. No.: US 2017/0153480 A1
(43) Pub. Date: Jun. 1, 2017

(54) LIQUID CRYSTAL DISPLAY PANEL

(71) Applicant: Shenzhen China Star Optoelectronics Technology Co. Ltd., Shenzhen, Guangdong (CN)

(72) Inventor: Qibiao Lv, Shenzhen City (CN)

(21) Appl. No.: 14/786,170

(22) PCT Filed: Oct. 12, 2015
(86) PCT No.: PCT/CN2015/091719

§ 371 Date: Oct. 22, 2015

(30) Foreign Application Priority Data
Sep. 2, 2015 (CN) 201510556399.6

(51) Int. Cl. G02F 1/1339; G02F 1/1362; G02F 1/1343; G02F 1/1335; G02F 1/1333

(52) U.S. Cl. CPC G02F 1/13394; G02F 1/133514; G02F 1/133512; G02F 1/133345; G02F 1/134309; G02F 1/136286; G02F 2201/123; G02F 2201/121; G02F 2001/133354; G02F 2001/134345

(57) ABSTRACT

The present invention provides a liquid crystal display panel. By providing one convex part respectively on the array substrate corresponding to two sides of each sub spacer, which is equivalent to forming one recess between two convex parts, and thus to make the sub spacer being wedged in the recess. Then, the horizontal offset hardly occurs to the array substrate and the color filter substrate. The issue of V-Crosstalk of the traditional liquid crystal display panel due to pixel light leak can be solved to promote the display quality of the display panel.

### FIELD OF THE INVENTION

The present invention relates to a display technology field, and more particularly to a liquid crystal display panel.

### BACKGROUND OF THE INVENTION

The LCD (Liquid Crystal Display) possesses advantages of thin body, power saving and no radiation to be widely used in many application scope. Most of the liquid crystal displays on the present market are back light type liquid crystal display devices, which comprise a liquid crystal display panel and a back light module. Generally, the liquid crystal display panel comprises a CF (Color Filter) substrate, a TFT (Thin Film Transistor) substrate, a LC (Liquid Crystal) sandwiched between the CF substrate and the TFT substrate and sealant.

As shown in FIGS. 1-3, which shows a liquid crystal display panel according to prior art. The liquid crystal display panel comprises an array substrate 10 and a color filter substrate 20 which are oppositely located, and a liquid crystal layer arranged between the array substrate 10 and the color filter substrate 20;

the array substrate 10 comprises a first substrate 11, and a first metal layer, a gate isolation layer 13, a second metal layer, a passivation layer 15 and a pixel electrode 16 on the first substrate 11; the first metal layer comprises a scan line 125 and a common electrode line 126; the second metal layer comprises a data line 141.

The color filter substrate 20 comprises a second substrate 21, a black matrix 22 and a color resist layer 23 located on the second substrate 21 and a common electrode 24 located on the black matrix 22 and the color resist layer 23.

In normal condition, for forming a certain gap between the array substrate 10 and the color filter substrate 20 for injecting liquid crystals, the photo spacer is manufactured in the last process of the color filter substrate 20. The function of the photo spacer is employed to support the array substrate 10 and the color filter substrate 20 to form a cell gap between the two substrates for filling the liquid crystals.

As shown in FIG. 4, the photo space in the liquid crystal display panel has two kinds: the main photospacer (Main PS) 25 and the sub photospacer (Sub PS) 26. The one which has support functions in the liquid crystal display panel is the main photospacer 25, and the sub photospacer 26 provides assist support function when the panel is pressed by an external force; according to design requirement, a protruding double metal stage 18 is design on the array substrate 10 corresponding to the main photospacer 25 to support the main photospacer 25. The layer structure of the array substrate 10 at the position of the double metal stage 18 is: the first substrate 11, the scan line 125, the gate isolation layer 13, the active layer 17, the metal block 142 and the passivation layer 15, which stack up from bottom to top in sequence; the metal block 142 belongs to the second metal layer as the same as the data line 141 does. In the liquid crystal panel after cell process, the main photospacer 25 constantly suffers a pressure to be in a compression state. Therefore, the actual height is smaller than the sub photospacer 26.

As shown in FIG. 5, which is a distribution diagram of the main spacer and the sub spacer in one pixel unit in the liquid crystal display panel according to prior art. As shown in FIG. 5, the pixel unit comprises three adjacent sub pixel areas 30. In each pixel unit, one main photospacer 10 and two sub photospacers 20 are correspondingly located, and evenly distributed in the three sub pixel areas 30.

In the traditional manufacture process of the liquid crystal display panel, both the array substrate 10 and the color filter substrate 20 are manufactured solo. Then, the array substrate 10 and the color filter substrate 20 are aligned to implement cell process.

As implementing cell process to the array substrate 10 and the color filter substrate 20, the misalignment is extremely easy to appear due to the restriction of alignment accuracy. The misalignment plus the substrate bent deformation can cause defects of light leak, the transmittance decrease and serious V-Crosstalk. Particularly for the large scale liquid crystal display panel (generally above 32 inches), the bent deformation can be more easily to happen to the upper, lower substrates, and the light leak phenomenon appears. As shown in FIG. 1, the edge region of the data line 141 in the sub pixel area 30 has light leak. Macroscopically, it causes the occurrence of the V-crosstalk in the black bottom white frame image, and seriously influences the display quality of the panel.

Generally, as the liquid crystal display panel is larger, the offset is easier to happen to the array substrate 10 and the color filter substrate 20. As shown in FIG. 3, the position where the light leak happens after the offset happens to the array substrate 10 and the color filter substrate 20 is the gap 50 between the data line 141 and the common electrode line 126; these gaps 50 is covered by the black matrix 22 in normal condition (as shown in FIG. 2). However, they are exposed due to the offset of the array substrate 10 and the color filter substrate 20 (as shown in FIG. 3).

Consequently, there is a need to provide a new type liquid crystal display panel for solving the aforesaid issues happening in the liquid crystal display panel according to prior art.

### SUMMARY OF THE INVENTION

An objective of the present invention is to provide a liquid crystal display panel, capable of solving the issues of light leak, V-Crosstalk phenomena of the present liquid crystal display panel due to the horizontal offset happening between the array substrate and the color filter substrate.

For realizing the aforesaid objective, the present invention provides a liquid crystal display panel, comprising an array substrate and a color filter substrate which are oppositely located, and a liquid crystal layer arranged between the array substrate and the color filter substrate;

the array substrate comprises a first substrate, and a first metal layer, a gate isolation layer, an active layer, a second metal layer, a passivation layer and a pixel electrode on the first substrate from bottom to top in sequence;

the color filter substrate comprises a second substrate, a black matrix and a color resist layer located on the second substrate, a common electrode located on the black matrix and the color resist layer, and a plurality of main spacers and a plurality of sub spacers located on the common electrode;

wherein one first convex part is provided on the array substrate correspondingly right under each main spacer, and two second convex parts are provided on the array substrate corresponding to two sides of each sub spacer, and then after the array substrate and the color filter substrate are assembled, the first main spacer is contacted and supported with the corresponding first convex part, and the sub spacer is wedged between the second convex parts at the two sides, then the array substrate and the color filter substrate are fastened together to prevent horizontal offset happening between the array substrate and the color filter substrate.

The first metal layer comprises a scan line and a common electrode line; the second metal layer comprises a data line and metal blocks corresponding to the first convex part and the second convex part.

The scan line and the data line are perpendicular with each other in a horizontal direction, and the common electrode line comprises a vertical common electrode line which is parallel with the data line and a horizontal common electrode line which is parallel with the scan line; a plurality of horizontal common electrode lines and a plurality of data lines are intersecting and perpendicular in the horizontal direction to surround and form a plurality of sub pixel areas.

Along with an extending direction of the horizontal common electrode line, every three adjacent sub pixel areas are a group to construct a pixel unit, and one main spacer and at least one sub spacer are provided on the color filter substrate corresponding to each pixel unit.

The one main spacer and at least one sub spacer on the color filter substrate corresponding to each pixel unit are evenly distributed in the three sub pixel areas.

One scan line is provided between two horizontal common electrode lines at two sides of each sub pixel area.

The main spacer and the sub spacer on the color filter substrate are located corresponding to the scan line, and the first convex part and the second convex part on the array substrate are located corresponding to the scan line.

Layer structures of the array substrate at locations of the first convex part and the second convex part are the same, and both comprise the first substrate, a scan line, the gate isolation layer, the active layer, the metal block and the passivation layer from bottom to top in sequence.

Length directions of the first convex part and the second convex part are consistent, and a length direction of the main spacer is perpendicular with the length direction of the first convex part, and a length direction of the sub spacer is parallel with the length direction of the second convex part.

Upper surfaces of the first convex part and the second convex part are plane.

The present invention further provides a liquid crystal display panel, comprising an array substrate and a color filter substrate which are oppositely located, and a liquid crystal layer arranged between the array substrate and the color filter substrate;

the array substrate comprises a first substrate, and a first metal layer, a gate isolation layer, an active layer, a second metal layer, a passivation layer and a pixel electrode on the first substrate from bottom to top in sequence;

the color filter substrate comprises a second substrate, a black matrix and a color resist layer located on the second substrate, a common electrode located on the black matrix and the color resist layer, and a plurality of main spacers and a plurality of sub spacers located on the common electrode;

wherein one first convex part is provided on the array substrate correspondingly right under each main spacer, and two second convex parts are provided on the array substrate corresponding to two sides of each sub spacer, and then after the array substrate and the color filter substrate are assembled, the first main spacer is contacted and supported with the corresponding first convex part, and the sub spacer is wedged between the second convex parts at the two sides, then the array substrate and the color filter substrate are fastened together to prevent horizontal offset happening between the array substrate and the color filter substrate;

wherein the first metal layer comprises a scan line and a common electrode line; the second metal layer comprises a data line and metal blocks corresponding to the first convex part and the second convex part;

length directions of the first convex part and the second convex part are consistent, and a length direction of the main spacer is perpendicular with the length direction of the first convex part, and a length direction of the sub spacer is parallel with the length direction of the second convex part;

wherein upper surfaces of the first convex part and the second convex part are plane;

The benefits of the present invention are: the present invention provides a liquid crystal display panel. By providing one convex part respectively on the array substrate corresponding to two sides of each sub spacer, which is equivalent to forming one recess between two convex parts, and thus to make the sub spacer being wedged in the recess. Then, the horizontal offset hardly occurs to the array substrate and the color filter substrate. The issue of V-Crosstalk of the traditional liquid crystal display panel due to pixel light leak can be solved to promote the display quality of the display panel.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a structural diagram of an array substrate in a liquid crystal display according to prior art;

FIG. 2 is a sectional diagram along the A-A′ section line in FIG. 1 when offset does not happen to the upper, lower substrates in the liquid crystal display panel according to prior art;

FIG. 3 is a sectional diagram along the A-A′ section line in FIG. 1 when offset happens to the upper, lower substrates in the liquid crystal display panel according to prior art;

FIG. 4 is a sectional diagram when a spacer is located in the liquid crystal display panel according to prior art;

FIG. 5 is a distribution diagram of the main spacer and the sub spacer in one pixel unit in the liquid crystal display panel according to prior art;

FIG. 6 is a distribution diagram of the main spacer and the sub spacer in one pixel unit in the liquid crystal display panel according to the present invention;

FIG. 7 is a sectional diagram along the B-B′ section line in FIG. 6 in the liquid crystal display panel according to the present invention;

FIG. 8 is a sectional diagram along the C-C′ section line in FIG. 6 in the liquid crystal display panel according to the present invention.

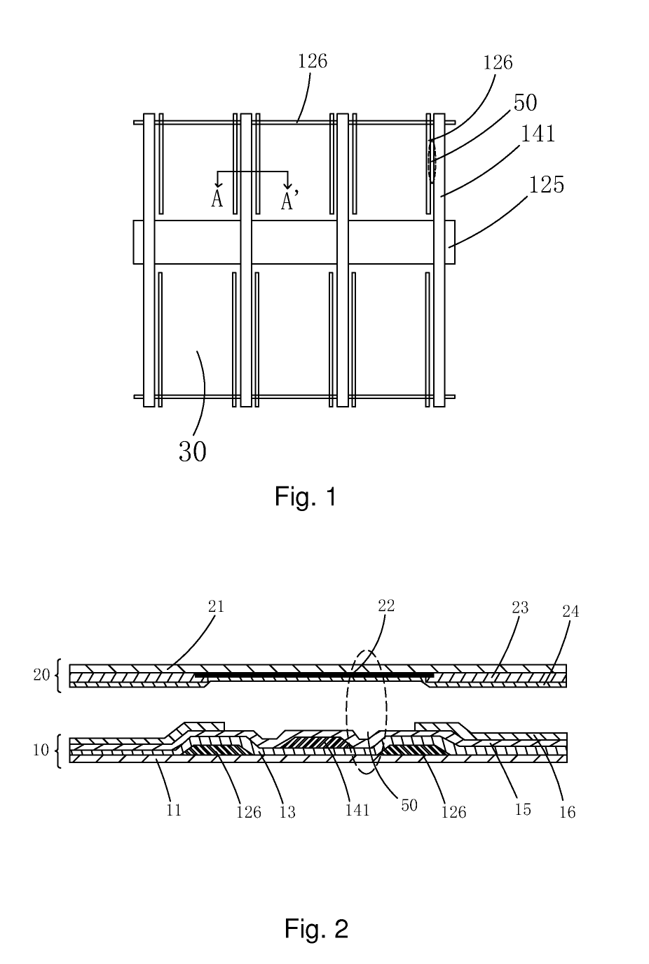

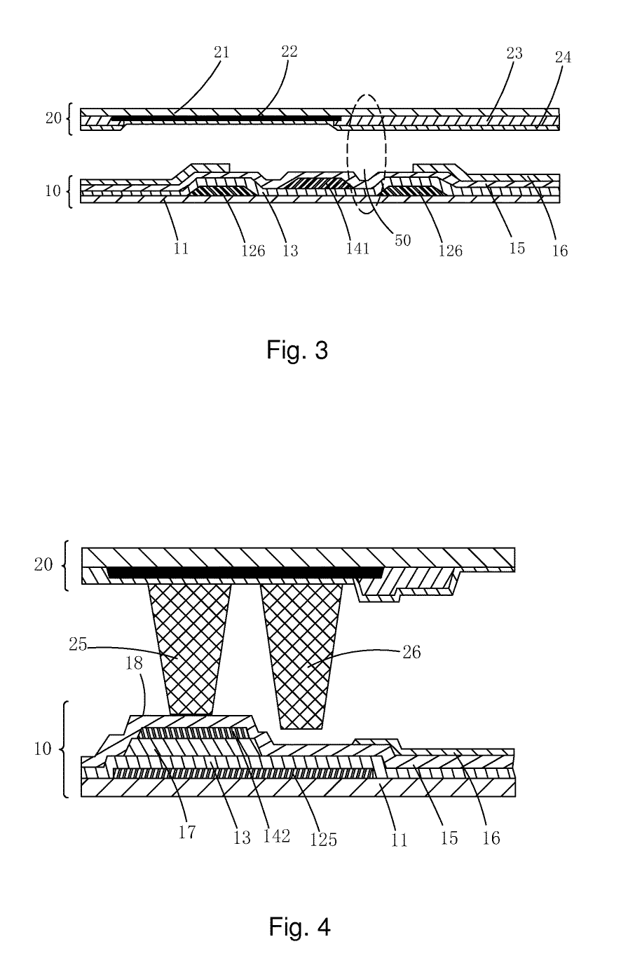

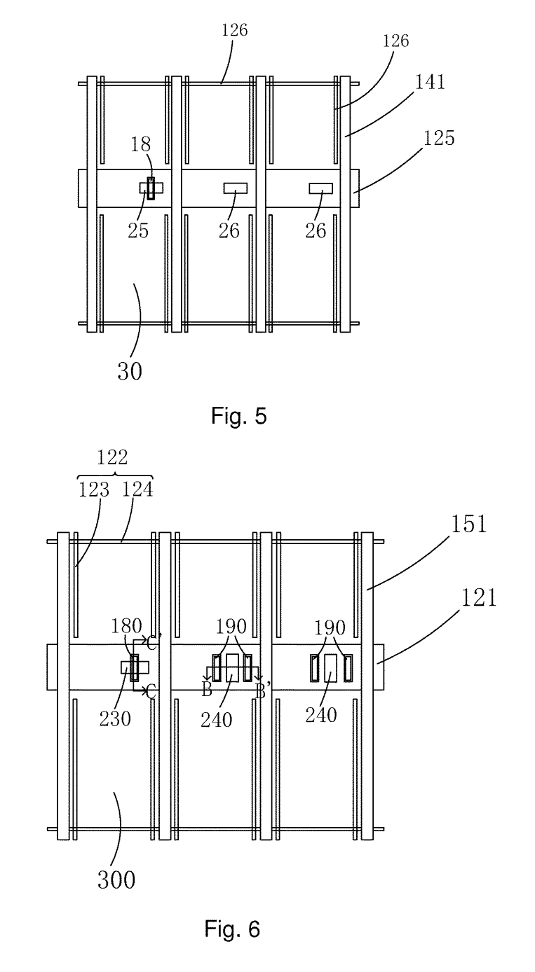

### DETAILED DESCRIPTION OF PREFERRED EMBODIMENTS

For better explaining the technical solution and the effect of the present invention, the present invention will be further described in detail with the accompanying drawings and the specific embodiments.

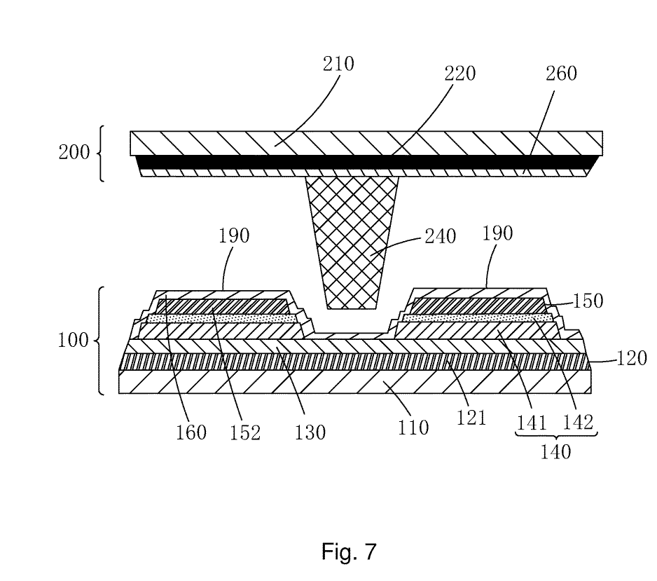

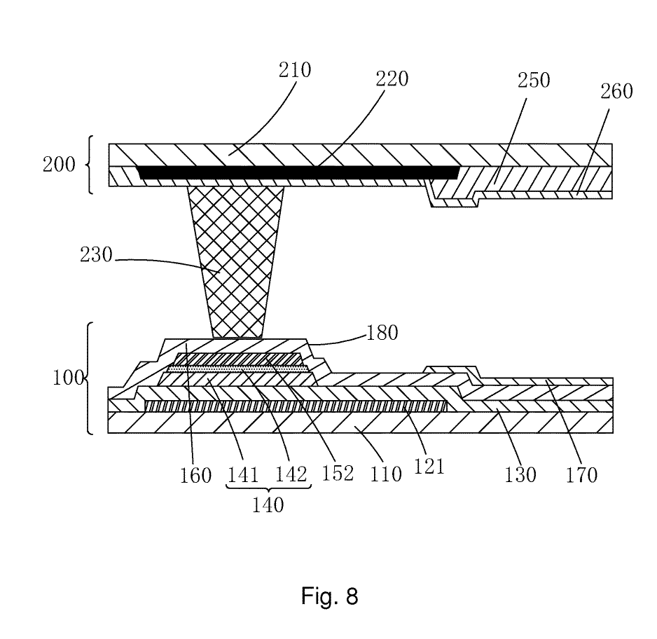

Please refer to FIGS. 6-8. The present invention provides a liquid crystal display panel, comprising an array substrate 100 and a color filter substrate 200 which are oppositely located, and a liquid crystal layer (not shown) arranged between the array substrate 100 and the color filter substrate 200;

the array substrate 100 comprises a first substrate 110, and a first metal layer 120, a gate isolation layer 130, an active layer 140, a second metal layer 150, a passivation layer 160 and a pixel electrode 170 on the first substrate 110 from bottom to top in sequence;

the color filter substrate 200 comprises a second substrate 210, a black matrix 220 and a color resist layer 250 located on the second substrate 210, a common electrode 260 located on the black matrix 220 and the color resist layer 250, and a plurality of main spacers 230 and a plurality of sub spacers 240 located on the common electrode 260;

wherein one first convex part 180 is provided on the array substrate 100 correspondingly right under each main spacer 230, and two second convex parts 190 are provided on the array substrate 100 corresponding to two sides of each sub spacer 240, and then after the array substrate 100 and the color filter substrate 200 are assembled, the first main spacer 230 is contacted and supported with the corresponding first convex part 180, and the sub spacer 240 is wedged between the second convex parts 190 at the two sides, then the array substrate 100 and the color filter substrate 200 are fastened together to prevent horizontal offset happening between the array substrate 100 and the color filter substrate 200.

Please refer to FIG. 6. The first metal layer 120 comprises a scan line 121 and a common electrode line 122; the second metal layer 150 comprises a data line 151 and metal blocks 152 corresponding to the first convex part 180 and the second convex part 190.

The scan line 121 and the data line 151 are perpendicular with each other in a horizontal direction, and the common electrode line 122 comprises a vertical common electrode line 123 which is parallel with the data line 151 and a horizontal common electrode line 124 which is parallel with the scan line 121; a plurality of horizontal common electrode lines 124 and a plurality of data lines 151 are intersecting and perpendicular in the horizontal direction to surround and form a plurality of sub pixel areas 300.

Specifically, along with an extending direction of the horizontal common electrode line 124, every three adjacent sub pixel areas 300 are a group to construct a pixel unit, and one main spacer 230 and at least one sub spacer 240 are provided on the color filter substrate 200 corresponding to each pixel unit.

Preferably, the one main spacer 230 and at least one sub spacer 240 on the color filter substrate 200 corresponding to each pixel unit are evenly distributed in the three sub pixel areas 300.

As shown in FIG. 6, one scan line 121 is provided between two horizontal common electrode lines 124 at two sides of each sub pixel area 300. The vertical common electrode lines 123 are distributed at two sides of the data line 151 and located at edge region of the sub pixel area 300, and is disconnected at position of the scan line 121.

Specifically, the main spacer 230 and the sub spacer 240 on the color filter substrate 200 are located corresponding to the scan line 121, and the first convex part 180 and the second convex part 190 on the array substrate 100 are located corresponding to the scan line 121.

Preferably, the main spacer 230, the sub spacer 240, the first convex part 180 and the second convex part 190 are all located corresponding to the center of the scan line 121.

Layer structures of the array substrate 100 at locations of the first convex part 180 and the second convex part 190 are the same, and both comprise the first substrate 110, the scan line 121, the gate isolation layer 130, the active layer 140, the metal block 152 and the passivation layer 160 from bottom to top in sequence.

As shown in FIG. 6, length directions of the first convex part 180 and the second convex part 190 are consistent, and a length direction of the main spacer 230 is perpendicular with the length direction of the first convex part 180, and a length direction of the sub spacer 240 is parallel with the length direction of the second convex part 190.

Specifically, upper surfaces of the first convex part 180 and the second convex part 190 are plane.

The heights of the main spacer 230 and the sub spacer 240 are manufactured to be the same. After the array substrate 100 and the color filter substrate 200 are assembled, the first main spacer 230 is contacted and supported with the corresponding first convex part 180 of the array substrate 100 to generate pressure to the main spacer 230 to make the main spacer 230 in a compression state, and the actual height is smaller than the sub spacer 240.

Specifically, both the first substrate 110 and the second substrate 210 are glass substrates.

The active layer 140 of the array substrate 100 comprises an amorphous silicon layer 141 and an n-type doping amorphous silicon layer 142 located on the amorphous silicon layer 141.

Specifically, the black matrix 220 on the color filter substrate 200 is located corresponding to the scan line 121 and the data line 151 on the array substrate 100, and the main spacer 230, the sub spacer 240, the first convex part 180 and the second convex part 190 are all located corresponding to the center of the scan line 121. Therefore, after the color filter substrate 200 and the array substrate 100 are assembled, the main spacer 230, the sub spacer 240, the first convex part 180 and the second convex part 190 are all covered by the black matrix 220 to not to influence the aperture ratio and the display quality of the liquid crystal display panel and to ensure the excellent performance of the product.

In conclusion, the present invention provides a liquid crystal display panel. By providing one convex part respectively on the array substrate corresponding to two sides of each sub spacer, which is equivalent to forming one recess between two convex parts, and thus to make the sub spacer being wedged in the recess. Then, the horizontal offset hardly occurs to the array substrate and the color filter substrate. The issue of V-Crosstalk of the traditional liquid crystal display panel due to pixel light leak can be solved to promote the display quality of the display panel.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A liquid crystal display panel, comprising an array substrate and a color filter substrate which are oppositely located, and a liquid crystal layer arranged between the array substrate and the color filter substrate;
the array substrate comprises a first substrate, and a first metal layer, a gate isolation layer, an active layer, a second metal layer, a passivation layer and a pixel electrode on the first substrate from bottom to top in sequence;
the color filter substrate comprises a second substrate, a black matrix and a color resist layer located on the second substrate, a common electrode located on the black matrix and the color resist layer, and a plurality of main spacers and a plurality of sub spacers located on the common electrode;
wherein one first convex part is provided on the array substrate correspondingly right under each main spacer, and two second convex parts are provided on the array substrate corresponding to two sides of each sub spacer, and then after the array substrate and the color filter substrate are assembled, the first main spacer is contacted and supported with the corresponding first convex part, and the sub spacer is wedged between the second convex parts at the two sides, then the array substrate and the color filter substrate are fastened together to prevent horizontal offset happening between the array substrate and the color filter substrate.

2. The liquid crystal display panel according to claim 1, wherein the first metal layer comprises a scan line and a common electrode line; the second metal layer comprises a data line and metal blocks corresponding to the first convex part and the second convex part.

3. The liquid crystal display panel according to claim 2, wherein the scan line and the data line are perpendicular with each other in a horizontal direction, and the common electrode line comprises a vertical common electrode line which is parallel with the data line and a horizontal common electrode line which is parallel with the scan line; a plurality of horizontal common electrode lines and a plurality of data lines are intersecting and perpendicular in the horizontal direction to surround and form a plurality of sub pixel areas.

4. The liquid crystal display panel according to claim 3, wherein along with an extending direction of the horizontal common electrode line, every three adjacent sub pixel areas are a group to construct a pixel unit, and one main spacer and at least one sub spacer are provided on the color filter substrate corresponding to each pixel unit.

5. The liquid crystal display panel according to claim 4, wherein the one main spacer and at least one sub spacer on the color filter substrate corresponding to each pixel unit are evenly distributed in the three sub pixel areas.

6. The liquid crystal display panel according to claim 3, wherein one scan line is provided between two horizontal common electrode lines at two sides of each sub pixel area.

7. The liquid crystal display panel according to claim 6, wherein the main spacer and the sub spacer on the color filter substrate are located corresponding to the scan line, and the first convex part and the second convex part on the array substrate are located corresponding to the scan line.

8. The liquid crystal display panel according to claim 7, wherein layer structures of the array substrate at locations of the first convex part and the second convex part are the same, and both comprise the first substrate, a scan line, the gate isolation layer, the active layer, the metal block and the passivation layer from bottom to top in sequence.

9. The liquid crystal display panel according to claim 1, wherein length directions of the first convex part and the second convex part are consistent, and a length direction of the main spacer is perpendicular with the length direction of the first convex part, and a length direction of the sub spacer is parallel with the length direction of the second convex part.

10. The liquid crystal display panel according to claim 1, wherein upper surfaces of the first convex part and the second convex part are plane.

11. A liquid crystal display panel, comprising an array substrate and a color filter substrate which are oppositely located, and a liquid crystal layer arranged between the array substrate and the color filter substrate;
the array substrate comprises a first substrate, and a first metal layer, a gate isolation layer, an active layer, a second metal layer, a passivation layer and a pixel electrode on the first substrate from bottom to top in sequence;
the color filter substrate comprises a second substrate, a black matrix and a color resist layer located on the second substrate, a common electrode located on the black matrix and the color resist layer, and a plurality of main spacers and a plurality of sub spacers located on the common electrode;
wherein one first convex part is provided on the array substrate correspondingly right under each main spacer, and two second convex parts are provided on the array substrate corresponding to two sides of each sub spacer, and then after the array substrate and the color filter substrate are assembled, the first main spacer is contacted and supported with the corresponding first convex part, and the sub spacer is wedged between the second convex parts at the two sides, then the array substrate and the color filter substrate are fastened together to prevent horizontal offset happening between the array substrate and the color filter substrate;
wherein the first metal layer comprises a scan line and a common electrode line;
the second metal layer comprises a data line and metal blocks corresponding to the first convex part and the second convex part;
length directions of the first convex part and the second convex part are consistent, and a length direction of the main spacer is perpendicular with the length direction of the first convex part, and a length direction of the sub spacer is parallel with the length direction of the second convex part;
wherein upper surfaces of the first convex part and the second convex part are plane;

12. The liquid crystal display panel according to claim 11, wherein the scan line and the data line are perpendicular with each other in a horizontal direction, and the common electrode line comprises a vertical common electrode line which is parallel with the data line and a horizontal common electrode line which is parallel with the scan line; a plurality of horizontal common electrode lines and a plurality of data lines are intersecting and perpendicular in the horizontal direction to surround and form a plurality of sub pixel areas.

13. The liquid crystal display panel according to claim 12, wherein along with an extending direction of the horizontal common electrode line, every three adjacent sub pixel areas are a group to construct a pixel unit, and one main spacer and at least one sub spacer are provided on the color filter substrate corresponding to each pixel unit.

14. The liquid crystal display panel according to claim 13, wherein the one main spacer and at least one sub spacer on the color filter substrate corresponding to each pixel unit are evenly distributed in the three sub pixel areas.

15. The liquid crystal display panel according to claim 12, wherein one scan line is provided between two horizontal common electrode lines at two sides of each sub pixel area.

16. The liquid crystal display panel according to claim 15, wherein the main spacer and the sub spacer on the color filter substrate are located corresponding to the scan line, and the first convex part and the second convex part on the array substrate are located corresponding to the scan line.

17. The liquid crystal display panel according to claim 16, wherein layer structures of the array substrate at locations of the first convex part and the second convex part are the same, and both comprise the first substrate, a scan line, the gate isolation layer, the active layer, the metal block and the passivation layer from bottom to top in sequence.
